(19) United States
(12) Patent Application Publication
(10) Pub. No.: US 2016/0004406 A1
(43) Pub. Date: Jan. 7, 2016

(54) ELECTRONIC DEVICE AND METHOD OF DISPLAYING A SCREEN IN THE ELECTRONIC DEVICE

(71) Applicant: Samsung Electronics Co., Ltd., Gyeonggi-do (KR)

(72) Inventors: Yoon-Jeong KANG, Gyeonggi-do (KR); Min-Kyung LEE, Gyeonggi-do (KR); Yoo-Jin HONG, Gyeonggi-do (KR); Lars Anders LARSSON, Malmo (SE); Michael Erik WINBERG, Malmo (SE); Nils Roger Andersson REIMER, Malmo (SE); Oskar Plaza OLIVESTEDT, Kristianstad (SE); Per Marcus ERIKSSON, Malmo (SE)

(73) Assignee: Samsung Electronics Co., Ltd.

(21) Appl. No.: 14/792,161

(22) Filed: Jul. 6, 2015

(30) Foreign Application Priority Data
Jul. 3, 2014 (KR) 10-2014-0083078

(51) Int. Cl. G06F 3/0487; G06F 3/0488; G06F 3/0486; G06F 3/0484

(52) U.S. Cl. CPC G06F 3/0487; G06F 3/04842; G06F 3/04883; G06F 3/0486

(57) ABSTRACT

An electronic device and a method of displaying screens in the electronic device are provided. The method includes displaying a plurality of objects respectively in a plurality of areas of a display of the electronic device; receiving a selection of one of the plurality of areas; identifying an object corresponding to the selected area; displaying a preliminary information screen for the identified object together with at least one unselected object; and displaying an execution screen of the identified object, if a selection of the preliminary information screen is received.

### PRIORITY

This application claims priority under 35 U.S.C. §119(a) to Korean Patent Application Serial No. 10-2014-0083078, which was filed in the Korean Intellectual Property Office on Jul. 3, 2014, the entire disclosure of which is incorporated herein by reference.

### BACKGROUND OF THE INVENTION

1. Field of the Invention

The present invention relates generally to an electronic device and a method of displaying a screen in the electronic device.

2. Description of the Related Art

Conventionally, when executing an application in an electronic device, as the application progresses from a first step to a next step, a screen of the next step is displayed as a full screen size, which replaces a screen associated with the first step. Alternatively, screens may be displayed in a stacked form in an order in which the screens are executed.

As such, in the related art, because a new screen occupies a full screen area, the new screen is disconnected from the state and information of the previous screen, and natural conversion to the next screen is difficult.

### SUMMARY OF THE INVENTION

The present invention has been made to address at least the above-described problems and/or disadvantages and to provide at least the advantages described below.

Accordingly, an aspect of the present invention is to provide a method for easy and intuitive manipulation for screen display and screen conversion, and an electronic device thereof.

Another aspect of the present invention is to provide a screen display method that uses minimal manipulations to controlling a view in the form of a list and that uses convenient scrolling procedure, and an electronic device thereof.

Another aspect of the present invention is to provide a method of displaying a view as a list with a part of information about individual areas of the list in order to easily recognize content of the individual areas, and an electronic device thereof.

Another aspect of the present invention is to provide a screen display method for returning to an initial screen through minimal manipulations, and an electronic device thereof.

In accordance with an aspect of the present invention, a method is provided for displaying a screen in an electronic device. The method includes displaying a plurality of objects respectively in a plurality of areas of a display of the electronic device; receiving a selection of one of the plurality of areas; identifying an object corresponding to the selected area; displaying a preliminary information screen for the identified object together with at least one unselected object; and displaying an execution screen of the identified object, if a selection of the preliminary information screen is received.

In accordance with another aspect of the present invention, an electronic device is provided, which includes a display configured to display a plurality of objects respectively in a plurality of areas; and a controller configured to receive a selection of one of the plurality of areas, to identify an object corresponding to the selected area, to display a preliminary information screen for the identified object with at least one unselected object on the display, and to display an execution screen of the identified object on the display, if a selection of the preliminary information screen is received.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 illustrates a network environment including an electronic device according to an embodiment of the present invention;

FIG. 2 illustrates an example of a screen including a plurality of objects that is displayed by an electronic device according to an embodiment of the present invention;

FIG. 3 is a flowchart illustrating a screen display method of an electronic device, according to an embodiment of the present invention;

FIGS. 4A to 4C illustrate a method for selecting an area in a screen displaying a list of objects, according to an embodiment of the present invention;

FIGS. 5A to 5C illustrate a method for stepwise displaying screens from a screen including a list of objects, according to an embodiment of the present invention;

FIGS. 6A to 6D illustrate a method for displaying screens through dragging from a screen including a list of objects, according to an embodiment of the present invention;

FIGS. 7A and 7B illustrate a stepwise screen display method according to an embodiment of the present invention; and

FIG. 8 illustrates a method for returning to an initial screen, according to an embodiment of the present invention.

Throughout the drawings, like reference numerals will be understood to refer to like parts, components, and structures.

### DETAILED DESCRIPTION

Hereinafter, various embodiments of the present invention will be described with reference to the appended drawings. However, specific structural and functional details disclosed herein are merely representative for purposes of describing example embodiments of the present disclosure, however, example embodiments of the present disclosure may be embodied in many alternate forms and should not be construed as limited to example embodiments of the present disclosure set forth herein.

Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure. Like numbers refer to like elements throughout the description of the figures.

Herein, the terms “comprises”, “may comprise,” “includes” and/or “may include,” specify the presence of stated functions, operations, and/or components, but do not preclude the presence or addition of one or more other functions, steps, and/or components. Further, the term “comprises” or “has” specifies the presence of stated features, integers, steps, operations, elements, components and/or groups thereof, but does not preclude the presence or addition of one or more other features, integers, steps, operations, elements, components, and/or groups thereof.

Herein, the term “or” or “at least one of A and/or B” includes any and all combinations of one or more of the associated listed items. For example, “A and/or B” or “at least one of A and/or B” may include A, B, or both A and B.

Although the terms first, second, etc., may be used herein to describe various components, these components should not be limited by these terms. For example, the terms do not limit the order and/or importance of the components. These terms are only used to distinguish one component from another. For example, a first user device and a second user device that are user devices indicate different user devices. For example, a first component could be termed a second component, and, similarly, a second component could be termed a first component, without departing from the scope of the present disclosure.

When a component is referred to as being “connected” or “coupled” to another component, the component can be directly connected or coupled to the other component or intervening components may be present. In contrast, when a component is referred to as being “directly connected” or “directly coupled” to another component, there are no intervening components present.

The terminology used herein is for the purpose of describing particular embodiments only and is not intended to be limiting of the invention. As used herein, the singular forms are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An electronic device according to various embodiments of the present invention may include a device with communication capability. For example, the electronic device may be at least one of a smart phone, a tablet Personal Computer (PC), a mobile phone, a video phone, an e-Book reader, a desktop PC, a laptop PC, a Netbook computer, a Personal Digital Assistant (PDA), a Portable Multimedia Player (PMP), a MP3 player, mobile medical equipment, a camera, or a wearable device (for example, a Head-Mounted-Device (HMD) such as electronic glasses, electronic clothes, electronic bracelet, electronic necklace, electronic Appcessory, electronic tattoo, or smart watch).

Further, the electronic device may include a smart home appliance with communication capacity. For example, the smart home appliance may be at least one of a Television (TV), a Digital Versatile Disk (DVD) player, audio equipment, a refrigerator, an air conditioner, a cleaner, an oven, a microwave oven, a washing machine, an air cleaner, a set-top box, a TV box (for example, Samsung HomeSync®, Apple TV®, Google TV®, etc.), game consoles, electronic dictionary, a camcorder, or an electronic album.

Additionally, the electronic device may include at least one of various medical equipment (for example, Magnetic Resonance Angiography (MRA) device, Magnetic Resonance Imaging (MRI) device, Computed Tomography (CT) device, medical camcorder, ultrasonic equipment, etc.), a navigation device, a Global Positioning System (GPS) receiver, an Event Data Recorder (EDR), a Flight Data Recorder (FDR), an automotive infotainment device, electronic equipment for a ship (for example, marine navigation device, gyro compass, etc.), avionics equipment, security equipment, a head unit for vehicle, an industrial or home robot, an Automatic Teller Machine (ATM), or a Point of Sales (PoS) device for a store.

Further, the electronic device may include at least one of a piece of furniture or a part of a building/structure with a display capability, an electronic board, an electronic signature receiving device, a projector, or various metering equipment (for example, water, electricity, gas, or waves metering equipment).

Additionally, the electronic device may include one of the aforementioned devices or a combination of one or more of the aforementioned devices.

Also, the electronic device may include a flexible device.

It will be apparent to those of ordinary skill in the art that the electronic device according to various embodiments of the present invention is not limited to the aforementioned devices.

In the following description, the term “user” may indicate a person or an apparatus (for example, an intelligent electronic device) that uses the electronic device.

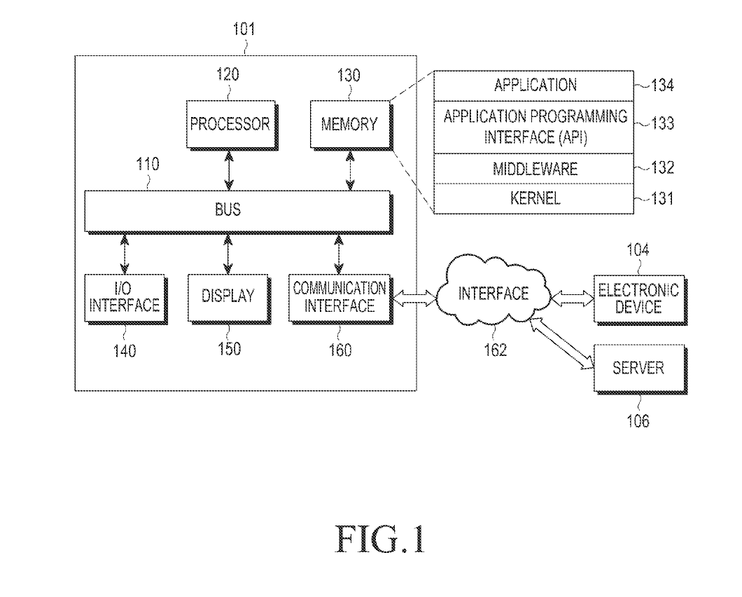

FIG. 1 illustrates a network environment including an electronic device, according to an embodiment of the present invention.

Referring to FIG. 1, the electronic device 101 includes a bus 110, a processor 120, a memory 130, an input/output (I/O) interface 140, a display 150, and a communication interface 160.

The bus 110 may be a circuit to connect the aforementioned components to each other, for communications (for example, transmission of control messages) between the aforementioned components.

The processor 120 receives commands from the memory 130, the input/output interface 140, the display 150, or the communication interface 160, through the bus 110, interprets the received commands, and performs operations or data processing according to the interpreted commands.

According to various embodiments of the present invention, a controller (not shown) may be provided, which includes the processor 120 and the memory 130 to store information required by the processor 120. The controller, e.g., a Central Processing Unit (CPU), controls the overall operations of the electronic device 101, and performs operations for a screen display method of the electronic device 101.

For example, the controller may control the display 150 to display a plurality of objects in a plurality of areas. The plurality of areas may be arranged in a plurality of rows, and accordingly displayed in the form of a list. Accordingly, the controller may store a layout for displaying objects in the form of a list, and the objects that are arranged in the layout, in the memory 130.

According to an embodiment of the present invention, the objects that are mapped to the individual areas of the display 150 may include various visual objects, such as shortcut icons for executing applications, content, messages, contact, call history, Social Network Service (SNS) content, widgets, and icons representing document with various formats of files, music files, text, and folders, or the objects may include visual objects selected from among the aforementioned visual objects. Also, the objects may include a variety of information that can be stored in a digital form in the electronic device 101.

The objects are applications that are executable on the electronic device 101. The objects may be stored in the electronic device 101, or may be downloaded from an external web server that provides applications. Also, each object may be created and displayed as a button or an icon made of an image, text, a picture, or a combination thereof. Also, each area may display information (for example, a name) for identifying the corresponding object, together with the object, and the information may include text, an image, etc.

Displaying objects in the form of a list may also be referred to as an “overview” or a “list view”. The overview displays items related to applications to be used sequentially on a screen (for example, a wallpaper or a home screen) in the form of text, bars, boxes, icons, or a combination of two or more of the aforementioned forms, including a plurality of rows and/or a plurality of columns, in order to check the applications and quickly enter the applications. The overview may be used when various functions, such as web search, e-book, mail list search, SMS search, or contact search are executed.

The list view displays some items among an entire list of items.

The controller may provide an interface method to move a selected list object according to a user input (for example, a touch input or a scroll input applied on a screen) in a list view. If an object of a certain area is selected in the list view, the controller may enlarge the selected area to a predetermined size.

The controller may detect a user input when, e.g., an electronic pen or a user's finger, touches, approaches, or is placed close to an object displayed in a respective area of the layout on the display 150, and may detect a location on the display 150, at which the user input is detected. Thereafter, the controller may identify an area of the layout, corresponding to the detected location on the display 150, and identify an object corresponding to the area. The user input through the display 150 may be any one of a direct touch input of directly touching an object, and a hovering input which is an indirect touch input of approaching an object within a predetermined distance from the object without directly touching the object. For example, by locating an input close to the display 150, an object located vertically below the input means may be selected. Alternatively or in addition, the user input may include a gesture input through a camera module, a switch/button input through a button or a keypad, and a voice input through a microphone.

If the controller determines that an area is selected, the controller may enlarge the selected area to a predetermined size, for example, to a size occupying a part of a full screen. The selected area may be enlarged to overlap other areas in the list, or the selected area may be enlarged to a predetermined size while some of the other areas may be arranged in the remaining space. Also, the selected area may be enlarged in an up-down direction to a predetermined size, while the remaining areas that are not selected maintain their positions without being pushed out. Further, the selected area may be activated and enlarged, while the remaining areas that are not selected are dimmed to represent a deactivated state. Further, the enlarged area may return to its original state if a button included in the enlarged area is pressed/touched or if a predetermined time period elapses.

A screen in which an enlarged area of an object is displayed with areas of remaining objects can be also referred to as a “light view”. For example, the light view includes a preliminary information screen in which preliminary information of an object corresponding to a selected area is displayed. The preliminary information of the object may be a part of information such as characteristics information of the object, and text or an image may be used to show the characteristics information of the object. Information that is displayed in the enlarged area may be information that describes the object, or event information that is updated in real time. That is, when a selected area is enlarged to a predetermined size, the enlarged area may include at least one part of currently collected event information. For example, predetermined event information may be collected according to the characteristics of an application corresponding to the selected area, and a part of the collected event information may be displayed.

Alternatively, an image and a portion of information that is normally provided by the application corresponding to the selected area may be displayed. Such preliminary information may be information edited such that a portion of information about each object is displayed, according to a predetermined method set in advance by the controller.

Alternatively, the preliminary information may be information provided by an application provider when the application provider downloads or updates the corresponding application.

If the controller determines that the enlarged area is selected, the controller may maximize the enlarged area to a full screen size. The full screen may display detailed information about the object corresponding to the selected area. For example, if an application exists in the selected area, an application execution screen may be displayed as a full screen. The full screen may also be referred to as a “dense view”.

In order to maximize the enlarged area, i.e., the preliminary information screen to a full screen, a user input may be applied on the preliminary information screen. Specifically, if a first input and a second input applied on the preliminary information screen are received, the preliminary information screen may be maximized to a full screen according to the second input. Further, if a third input applied on the full screen is received when the full screen is displayed due to execution of the object corresponding to the enlarged area, an initial screen, i.e., an overview state may be displayed according to the third input.

For example, each of the first input, the second input, and the third input may be at least one of a single touch input, a double touch input, a drag input having up/down/left/right directivity, and a tap input.

For example, by performing a drag operation or a flick operation, the preliminary information screen may be maximized to a full screen according to execution of the object. For example, if a user touches the preliminary information screen and drags in the up direction, a full screen may spread out. Further, if a user scrolls down on the full screen or taps a return button, an overview, which is an initial step, may be displayed.

For conversion between the overview, the light view, and the dense view, the controller may detect various user inputs received through a camera module or a sensor module, as well as the display 150. Further, the user input may also include various kinds of information, such as a user gesture, voice, pupil movement, or a biometric signal, which is input to the electronic device 101.

Basically, the controller may perform a predetermined operation or function corresponding to the detected user input.

According to an embodiment of the present invention, an execution screen of an object, which is displayed as a full screen, may be configured with a plurality of steps. In this case, when a user input is applied to a predetermined location in the full screen, the full screen may return to the initial or previous execution step of the object. For example, if a user wants to return to an initial execution step after two or more steps have already progressed, the user may return to the initial execution step by performing a minimal manipulation of scrolling down the screen while maintain a touch input in an upper part of the screen, without having to press a back button several times.

According to the embodiment of the present invention, by stepwise displaying the object execution steps, such as an overview, a light view, and a dense view, a user can easily recognize a desired object and understand the content of the object. Additionally, by providing a user with a preview of a selected object before executing the selected object, a seamless effect upon conversion between applications or between application screens can be provided.

Further, because movement (jumping) to the uppermost step is possible with minimal manipulations, navigation to a previous screen with minimal manipulation is also possible.

The memory 130 may store commands or data received from or created by the processor 120, the input/output interface 140, the display 150, or the communication interface 160. For example, the memory 130 may include programming modules, such as a kernel 131, middleware 132, an Application Programming Interface (API) 133, an application 134, etc. Each of the programming modules may be software, firmware, hardware, or a combination of two or more of software, firmware, and hardware.

The kernel 131 may control or manage system resources (for example, the bus 110, the processor 120, or the memory 130) which the other programming modules (for example, the middleware 132, the API 133, or the application 134) use to execute their operations or functions. Also, the kernel 131 may provide an interface for the middleware 132, the API 133, or the application 134 to access individual components of the electronic device 101 and to control or manage the components.

The middleware 132 may act as an intermediary for the API 133 or the application 134 to communicate with the kernel 131. The middleware 132 may perform, when operation requests are received from the application 134 (or a plurality of applications 134), controlling (e.g., scheduling or load balancing) for the operation requests, by allocating priority capable of using a system resource (e.g., the bus 110, the processor 120, or the memory 130) of the electronic device 101 to the application 134.

The API 133 may be an interface for the application 134 to control functions that are provided by the kernel 131 or the middleware 132. For example, the API 133 may include at least one interface or function for file control, window control, image processing, characters control, etc.

The input/output interface 140 may transfer a command or data received from a user through an input/output device (e.g., a sensor, a keyboard, or a touch screen) to the processor 120, the memory 130, or the communication interface 160, for example, through the bus 110. The input/output interface 140 may provide data about an input received through a touch screen, to the processor 120.

According to an embodiment of the present invention, an input device of the input/output interface 140 may include a touch panel, a (digital) pen sensor, a key, or an ultrasonic input device. The touch panel may be a capacitive type, a resistive type, an infrared type, or an ultrasonic type. The touch panel may be implemented as at least one panel that can recognize a user's various inputs including a single- or multi-touch input, a drag input, a writing input, and a drawing input, using a finger or an object such as a pen.

For example, the touch panel may be implemented using a panel that can recognize both finger inputs and pen inputs. Also, the touch panel may be implemented using two panels including a touch recognition module that can recognize finger inputs and a pen recognition module that can recognize pen inputs. The touch panel may also include a control circuit.

If the touch panel is a capacitive type, the touch panel can recognize proximity as well as physical contact.

The touch panel may also include a tactile layer. In this case, the touch panel may give a user tactile impression.

The input/output interface 140 may output a command or data received from the processor 120, the memory 130, or the communication interface 160, via the bus 110, through an input/output device (e.g., a speaker or a display).

The display 150 may display a variety of information, such as multimedia data or text data, for a user. Also, according to an embodiment of the present invention, the display 150 may display a screen, such as wallpaper or a home screen, in which objects are arranged in a plurality of rows.

The display 150 may be a touch screen including a display panel to display information output from the electronic device 101, and an input panel to enable a user to input various commands. For example, the display panel may be a Liquid-Crystal Display (LCD) or an Active-Matrix Organic Light-Emitting Diode (AM-OLED).

The display panel may display various screens according to various operation states of the electronic device 101, execution of an application, or a service. According to an embodiment of the present invention, the display panel displays a screen including areas in which objects are arranged in a plurality of rows.

The input panel may be implemented as at least one panel that can recognize a user's various inputs including a single- or multi-touch input, a drag input, a writing input, and a drawing input, using a finger or an object such as a pen. For example, the input panel may be implemented using a panel that can recognize both finger inputs and pen inputs.

The input panel may also be implemented using two panels including a touch recognition module that can recognize finger inputs and a pen recognition module that can recognize pen inputs.

The touch screen may output a signal corresponding to at least one user input inputted to a user graphic interface, to a touch screen controller. The touch screen may receive at least one touch input through a user's body part (for example, a user's finger). The touch screen may receive a touch-and-drag input. The touch screen may output an analog signal corresponding to the touch-and-drag input to the touch screen controller.

Herein, the term “touch” is not limited to actual contact, but may also include non-contact recognition (for example, when the user input device is placed within a recognition distance (e.g., 1 cm) from the touch screen without directly contacting the touch screen). The recognition distance in which the touch screen can recognize the user input may depend on the performance or structure of the electronic device 101.

For example, in order to distinguish a direct touch event of actual contact of the user from an indirect touch event (e.g., a hovering event) of a non-contact recognition, the touch screen may be configured to output different values (e.g., voltage values or current values as analog values) with respect to the direct touch event and the hovering event.

The touch screen may be a resistive touch screen, a capacitive touch screen, an infrared touch screen, an acoustic wave touch screen, or a combination thereof.

The touch screen controller may convert an analog signal received from the touch screen into a digital signal, and transmit the digital signal to the controller. The controller may control a user interface that is displayed on the touch screen, using the digital signal received from the touch screen controller. For example, the controller may select or execute a shortcut icon or an object displayed on the touch screen, in response to a direct touch event or a hovering event. The touch screen controller may be integrated with the controller.

The touch screen controller may detect a value (e.g., a current value) output through the touch screen to calculate a user input location and a value of a distance between a space in which a hovering event has occurred and the touch screen, convert the distance value into a digital signal (e.g., Z coordinate), and provide the digital signal to the controller.

The communication interface 160 connects the electronic device 101 with an external electronic device (e.g., the electronic device 104 or the server 106). For example, the communication interface 160 may connect to a network 162 through wired or wireless communication to communicate. The wireless communication may include at least one of Wireless Fidelity (WiFi), Bluetooth® (BT), Near Field Communication (NFC), Global Positioning System (GPS), or cellular communication (for example, Long-Term Evolution (LTE), Long-Term Evolution Advanced (LTE-A), Code Division Multiple Access (CDMA), Wideband Code Division Multiple Access (WCDMA), Universal Mobile Telecommunications System (UMTS), Wireless Broadband (WiBro), Global System for Mobile Communications (GSM), and the like). The wired communication may include at least one of a Universal Serial Bus (USB), a High Definition Multimedia Interface (HDMI), Recommended Standard 232 (RS-232), or a Plain Old Telephone Service (POTS).

According to an embodiment of the present invention, the network 162 may be a telecommunications network including at least one of a computer network, the Internet, the Internet of Things (IoT), or a telephone network.

According to an embodiment of the present invention, a protocol (for example, a transport layer protocol, a data link protocol, or a physical layer protocol) for communication between the electronic device 101 and an external electronic device may be supported by at least one of the application 134, the API 133, the middleware 132, the kernel 131, or the communication interface 160.

Each of the above-described units of the electronic device 101 may be configured with one or more components, and the units may be termed according to a kind of the corresponding electronic device 101. The electronic device 101 may include at least one of the above-described units, or the electronic device 101 may omit some of the above-described units or further include another unit(s). Further, some of the units of the electronic device 101 may be combined to constitute entity which performs the same functions as the corresponding units.

The term “module” used herein means a unit including, for example, hardware, software, firmware, or a combination thereof, and may be interchangeably used with another term, such as “unit”, “logic”, “logical block”, “component”, or “circuit”. The module may be a minimum unit or a part of components integrated into one body. Also, the module may be a minimum unit or a part for performing one or more functions.

A module may be implemented mechanically or electronically. For example, the module may include at least one of an Application-Specific Integrated Circuit (ASIC) chip, Field-Programmable Gate Arrays (FPGAs), or a programmable-logic device, which performs certain operations, already developed or to be developed in future.

According to various embodiments of the present invention, at least one part of an apparatus (for example, modules or their functions) or method (for example, operations) may be implemented as an instruction stored in computer-readable storage media, for example, in the form of a programming module. When the instruction is executed by one or more processors (for example, the processor 120), the one or more processors may perform a function corresponding to the instruction. The computer-readable storage media may be, for example, the memory 130. At least one part of the programming module may be implemented (for example, executed) by the processor 120. At least one of the programming modules may include a module, a program, a routine, sets of instructions, or a process for performing one or more functions.

The computer-readable storage media may include magnetic media (for example, a hard disk, a floppy disk, and a magnetic tape), optical media (for example, Compact Disc Read Only Memory (CD-ROM) and Digital Versatile Disc (DVD)), magneto-optical media (for example, floptical disk), and hardware device (for example, Read Only Memory (ROM), and Random Access Memory (RAM), and flash memory) configured to store and perform a program instruction (for example, a programming module). The programming instruction may include a high-level language code that can be executed by a computer using an interpreter, as well as a machine code that is created by a compiler. The hardware device may be configured to operate as at least one software module for performing operations according to various embodiments of the present disclosure, and vice versa.

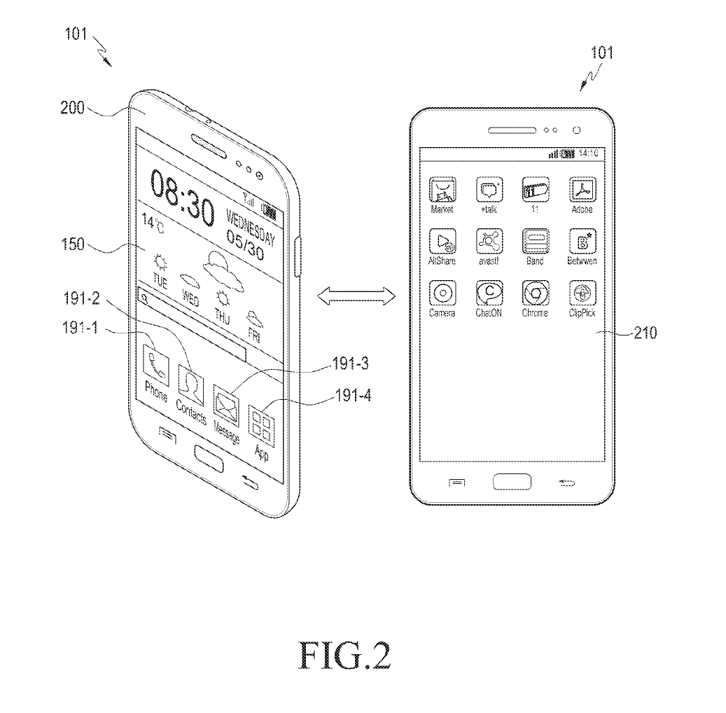

FIG. 2 illustrates an example of a screen including a plurality of objects this is displayed by an electronic device according to an embodiment of the present invention.

Referring to FIG. 2, the display 150 occupies a major portion of a front side 200 of the electronic device 101.

In FIG. 2, a main home screen is displayed on the display 150. The main home screen is a screen that is first displayed on the display 150 when the electronic device 101 is powered on. If the electronic device 101 has different home screens of several pages, the main home screen may be a first home screen among the home screens of the several pages.

In the home screen, includes shortcut icons 191-1, 191-2, and 191-3 for executing specific applications, and a main menu conversion key 191-4. If a user selects the main menu conversion key 191-4, a menu screen 210 including a plurality of application icons are displayed on the display 150.

In the menu screen 210, various visual objects such as shortcut icons for executing applications that are executable on the electronic device 101 are arranged in a matrix form of rows and columns. As such, the electronic device 101, which is a smart phone or a table PC, may store several applications herein. Accordingly, in order for a user to execute a desired application using the electronic device 101, to the user will turn through pages of the menu screen 210 to find a desired application from among many applications, which may take a long time.

According to various embodiments of the present invention, by arranging objects for executing applications in a plurality of areas including a plurality of rows on the touch screen 190, a user can quickly find a desired object by scrolling through the pages, and when the user selects an area, the user can see brief information about the corresponding object, which facilitates a selection of an object.

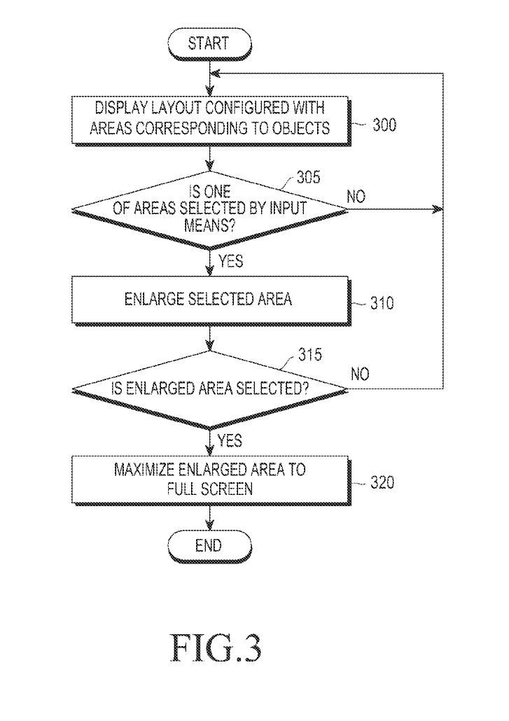

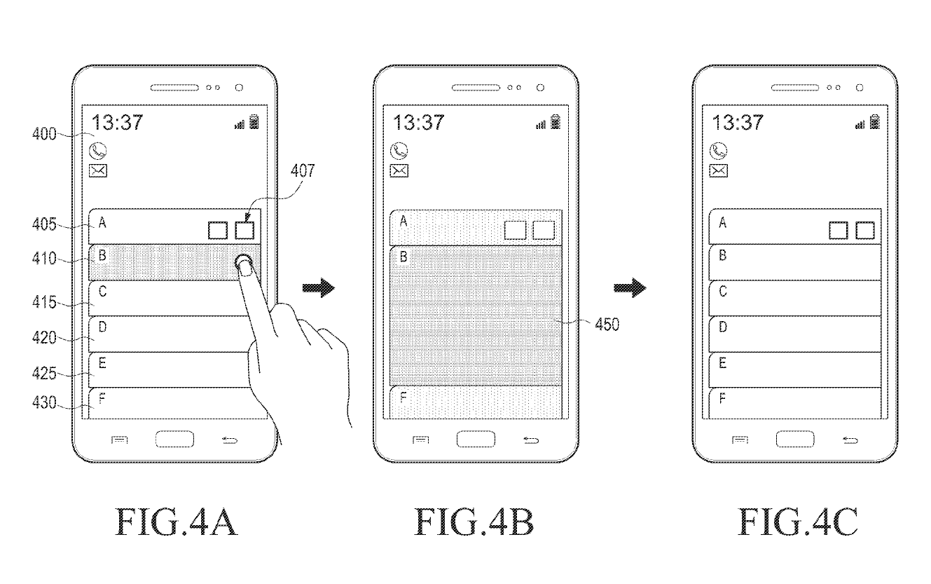

FIG. 3 is a flowchart illustrating a screen display method of an electronic device, according to an embodiment of the present invention. Although the screen display method of FIG. 3 will be described with reference to FIGS. 4A to 4C, the method of FIG. 3 is not limited to the example screen displays illustrated in FIGS. 4A to 4C.

Referring to FIG. 3, the electronic device displays a layout including a plurality of areas respectively corresponding to a plurality of objects, in step 300. For example, the layout may be displayed on a home screen or a menu screen, and the respective areas of the layout may display applications, each configured with a plurality of steps, names of the applications, and brief contents of the applications. Each area configuring the layout may be also referred to as a slice, a grid, a frame, a section, and a card.

Referring to FIG. 4A, the layout includes a plurality of areas 405, 410, 415, 420, 425, and 430 arranged in a plurality of rows is displayed on a home screen 400. Objects 407 that can be displayed in the respective areas 405, 410, 415, 420, 425, and 430 may be shortcut icons for executing the applications, and names of the applications. The objects 407 may also include various kinds of visual objects, such as components (for example, pictures, illustrations, characters (letterings or logos), and symbols) and various contents (for example, text, widgets, icons representing document with various formats of files, and folders). The objects 407 may also include one or more visual objects selected from among the aforementioned visual objects.

The layout may be edited, deleted, and created according to a user's tastes, and may be downloaded. The individual areas configuring the layout may be set to have different sizes depending on importance and frequency of use. The areas may also be set to have the same size. Because the layout in FIG. 4A is in the form of a list view, a portion of the entire list, e.g., items A to F, are displayed, while next items, e.g., items G to Z, may be displayed through scrolling.

Referring again to FIG. 3, the electronic device determines when any of the areas is selected in step 305. The selection of an area may be done by touching the screen or moving an indicator. When an area is selected in step 305, the selected area is enlarged in step 310.

FIG. 4A illustrates a user touching area 410, and when the electronic device determines that area 410 is selected, the electronic device enlarges the selected area 410 to a predetermined size 450, in step 310, as illustrated in FIG. 4B.

Referring to FIG. 4B, when the area 410 is selected, the selected area 450 may be enlarged in an up-down direction to a predetermined size, and the remaining areas 405 and 430 are displayed in a deactivated state. The enlarged area 450 also overlaps some remaining areas not selected, i.e., areas 415 to 425.

According to an embodiment of the present invention, when an area is selected, the electronic device identifies an object corresponding to the selected area, and then displays preliminary information about the object in the form of a preview in the enlarged area before executing the identified object.

Although FIG. 4A illustrates a list view configured with a plurality of rows, the method is also applicable to the menu screen 210 illustrated in FIG. 2. For example, if an application is selected on the menu screen 210 of FIG. 2, preliminary information about the selected application may be displayed in the form of a box.

Although FIG. 4A illustrates an example in which a plurality of areas are arranged in a plurality of rows, the plurality of areas may be arranged in a plurality of columns instead.

For example, the plurality of areas may have the same size or different sizes, or may be arranged in a matrix form consisting of rows and columns, but a configuration of the layout including the plurality of areas is not limited to these examples.

Because the list view illustrated in FIG. 4A allows intuitive navigation through up/down scrolling, a user can quickly search for a desired object, and easily recognize the content of an object corresponding to a selected area because the light view shows the brief content of the object, which facilitates the user's selection of an object. Further, when the layout in the list view is displayed, a user can request execution of a desired object. For example, the user may execute the desired object by selecting an icon for executing the object, located in the corresponding area.

In FIG. 4B, the enlarged area 450 may display information about a corresponding object in the form of text or an image. For example, the information that is displayed in the enlarged area 450 may be information that describes the object, or event information that is updated in real time. Basically, when the selected area 410 is enlarged to a predetermined size and displayed, the enlarged area 450 displays some currently collected event information.

In view of the above, the user can check brief content of an application through the light view in order to determine whether to select the corresponding application, unlike the related art in which the user actually selects an application and views an application execution screen in order to check content of the application. Therefore, the user can immediately access desired information against without having to open an application execution screen, which offers a user a wide range of choice.

Referring again to FIG. 3, in step 315, the electronic device determines whether the enlarged area 450 is selected. If the electronic device determines that no input is applied on the enlarged area 450, the operation returns to step 300, as illustrated in FIG. 4C.

However, if the electronic device determines that the enlarged area 450 is selected in step 315, in step 320, the electronic device maximizes the enlarged area 450 to a full screen of the display.

Again, selecting the enlarged area 450 may be done by a touch-and-drag input of touching and dragging up the enlarged area 450. At this time, the electronic device may identify an object corresponding to the enlarged area 450 and perform conversion to an execution screen of the identified object, while maximizing the enlarged area 450 to a full screen. That is, the electronic device may perform conversion to a full screen while executing the identified object. Accordingly, the full screen, which is an object execution screen, may display detailed information of content displayed in the enlarged area 450.

As such, a primary selection of an area enlarges the size of the area to a predetermined size, and a secondary selection of the enlarged area executes an object corresponding to the area, while maximizing an execution screen of the object to a full screen.

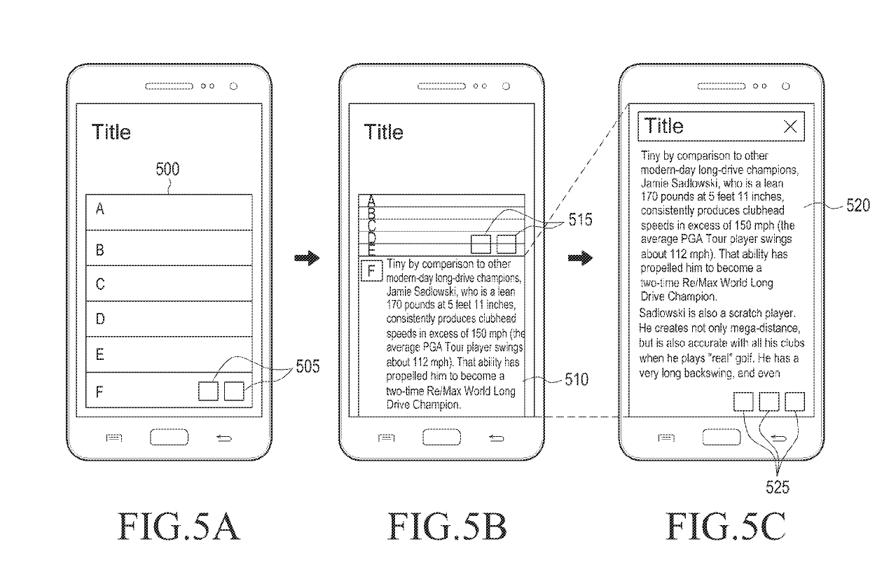

FIG. 5A illustrate a layout 500 in the form of a list view, wherein the layout 500 include operation buttons 505. If item F is selected from among items A to F of a list illustrated in FIG. 5A, an area of the selected item F is enlarged to a predetermined size, as illustrated in FIG. 5B, before an application corresponding to the selected item is executed. When the area of the selected item F is enlarged, the sizes of the remaining areas A to E are reduced, as illustrated in FIG. 5B, such that the remaining areas A to E may maintain their positions without being pushed out of the screen.

The enlarged area 510 may display preliminary information related to characteristics of the application.

The operations buttons 515 are still displayed near the enlarged area 510, and are used to proceed to a next step or to return to the previous step.

Thereafter, if the enlarged area 510 is selected, i.e., if an execution request is received, the application is executed so that the enlarged area 510 is converted to a full screen 520, as illustrated in FIG. 5C.

Selecting the enlarged area 510 may be done by a user input applied on the enlarged area 510. For example, the object may be executed when a user touches the enlarged area 510 one time or two times. Because an execution request is processed by spreading out an area on a screen and a return request is processed by folding an area on a screen, a user can perform an intuitive input.

In FIG. 5C, operation buttons 525 are displayed on the full screen 520.

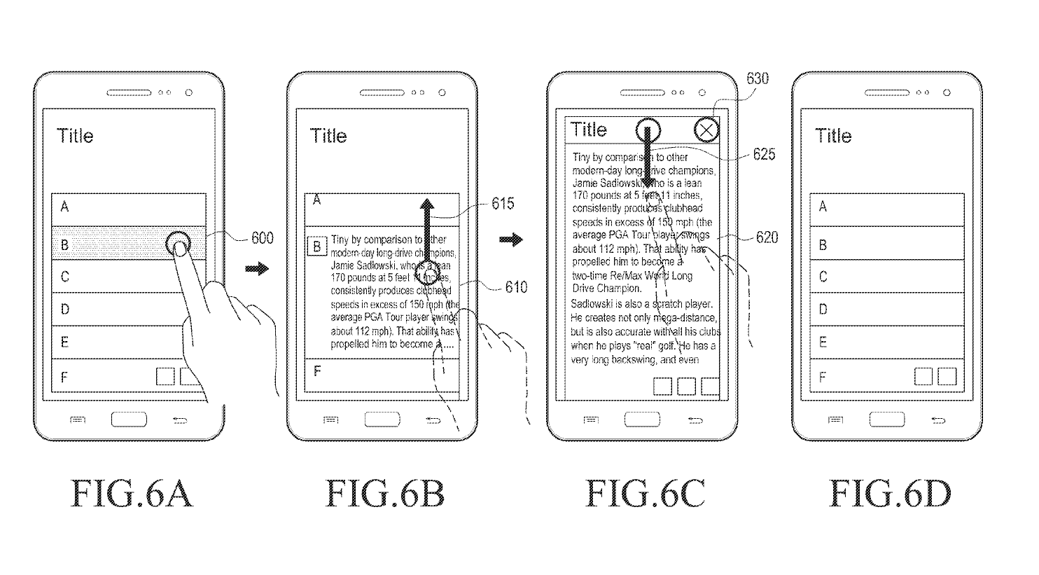

FIGS. 6A to 6D illustrate a method of displaying screens by dragging from a screen displaying a list of objects, according to an embodiment of the present invention.

Referring to FIG. 6A, if an area 600 is selected from among a plurality of areas displayed in a list view on a screen of an initial step, the area 600 is enlarged to an enlarged area 610 as illustrated in FIG. 6B. An object that is mapped to the selected area 600 may be identified, and preliminary information about the identified object may be displayed in the enlarged area 610. If a user wants to see detailed content of the enlarged area 610, the user may touch and drag the enlarged area 610 in an up direction as indicated by an arrow 615. As a result, the enlarged area 610 is maximized to a full screen 620, as illustrated in FIG. 6C. As the enlarged area 610 that displays the preliminary information is maximized to the full screen 620 according to the touch-and-drag input from the user, an object corresponding to the enlarged area 610 may be identified, and the identified object may be executed.

The full screen 620 (also, referred to as an object execution screen) may display more detailed information than the enlarged area 610 of FIG. 6B, and execute the object of the selected area 600 (see FIG. 6A). If the user wants to return to the screen of the initial step from the object execution screen 620, the user may press an “X” button 630 or touch and drag the upper part of the screen in a down direction as indicated by an arrow 625. Thereafter, the object execution screen 620 converts back to a screen of the initial or previous step, as illustrated in FIG. 6D.

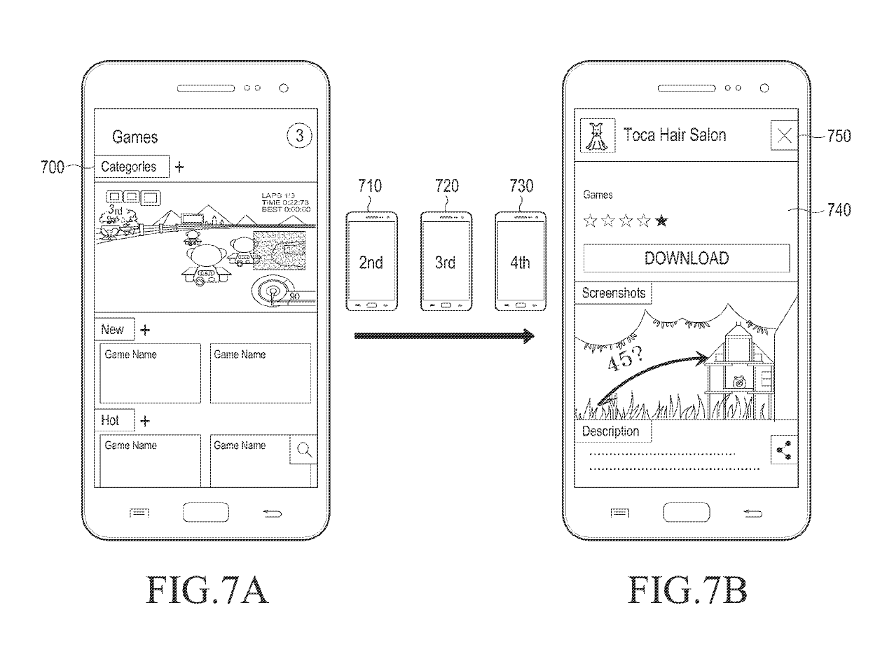

FIGS. 7A to 7B illustrate a stepwise screen display method according to an embodiment of the present invention. In FIG. 7, an application configured with a plurality of steps will be described as an example.

Referring to FIG. 7A, an application execution screen 700 of a first step is illustrated, and referring to FIG. 7B, an application execution screen 740 of a final step is illustrated via application execution screens 710, 720, and 730 of second, third, and fourth steps, respectively. If a user presses an “X” button 750 on the application execution screen 740 or touches and drags down the upper part of the application execution screen 740, the application execution screen 740 of the final step may return to the application execution screen 700 of the first step as illustrated in FIG. 7A. When an application is configured with two or more steps as illustrated in FIG. 7, a method is provided for returning to an initial step through a one-time manipulation without having to pressing a back button several times, according to an embodiment of the present invention.

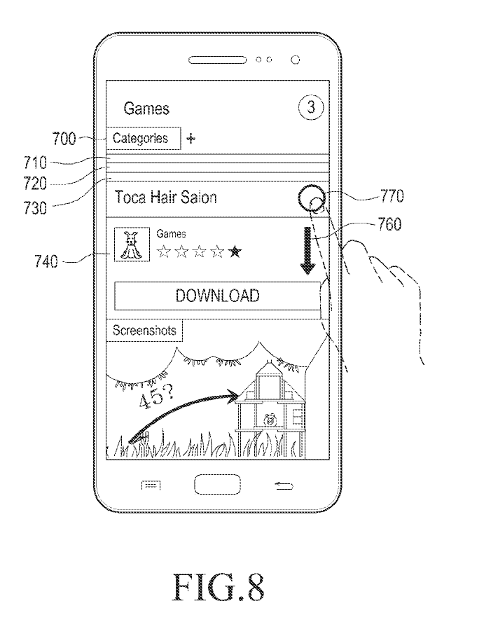

FIG. 8 illustrates a method of returning to an initial screen, according to an embodiment of the present invention.

In order to return to the screen 700 of the first step from the current screen 740 in a dense view, a back icon 770 may be provided on the upper part of the current screen 740. For example, if a user touches and drags the upper part of the current screen 740 in a down direction indicated by an arrow 760, the screen 700 of the first step may be displayed. More specifically, if the user touches and drags down the upper part of the current screen 740 by a predetermined distance, the current screen 740 may disappear and the screen 700 of the first step may appear.

Alternatively, when the back icon 770 is touched for a predetermined time period, the current screen 740 may return to the screen 700 of the first step.

The views 710, 720, and 730 of the progressed steps may be shown in a stacked form. If the user touches and drags down the upper part of the current screen 740, the stacked views 710, 720, and 730 may move downward according to the touch-and-drag operation. If the user touches and drags down the upper part of the current screen 740 by a predetermined distance or more, the views 710, 720, and 730 may disappear out of the screen from the down, and then the screen 700 of the first step may appear.

If a user input of touching and dragging down the upper part of a screen of a current execution step is received when an object of an area selected by a user is configured with a plurality of execution steps, and two or more execution steps have already progressed, the current screen may return to a screen of the initial or previous execution step of the object according to the user input.

Various embodiments of the present disclosure may be realized in the form of hardware, software, or a combination of hardware and software. Any such software may be stored in volatile or non-volatile storage such as, for example, a storage device like a ROM, whether erasable or rewritable or not, in memory such as, for example, RAM, memory chips, device or integrated circuits, or in an optically or magnetically writable, machine (e.g., a computer)-readable medium such as, for example, a CD, a DVD, a magnetic disk or magnetic tape, etc. A memory that can be included in the electronic device is an example of a machine-readable storage medium suitable to store a program or programs including instructions for implementing various embodiments of the present invention.

Accordingly, the methods according to the embodiments of the present invention include a program comprising code for implementing an apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

An electronic device according to an embodiment of the present invention may receive and store a program from a program providing apparatus connected through wire or wirelessly to the electronic device. The program providing apparatus may include a program including instructions for instructing the electronic device to perform the screen display method, memory to store information needed to perform the screen display method, a communication unit to perform wired or wireless communication with the electronic device, and a controller to transmit the program to the electronic device according to a request from the electronic device or automatically.

As described above, in the screen display method according to various embodiments of the present invention, it is possible to return to a previous screen including an initial screen with minimal manipulation.

According to the above-described embodiments of the present invention, by providing a screen that shows a list of objects together with information about individual items of the list, a user can easily recognize content of each area, which facilitates the user's selection of an object.

In addition, by providing an intuitive user interface for screen display and screen conversion, a user can conveniently convert or display a screen,

While the present invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method of displaying screens in an electronic device, the method comprising:
displaying a plurality of objects respectively in a plurality of areas of a display of the electronic device;
receiving a selection of one of the plurality of areas;
identifying an object corresponding to the selected area;
displaying a preliminary information screen for the identified object together with at least one unselected object; and
displaying an execution screen of the identified object, if a selection of the preliminary information screen is received.

2. The method of claim 1, wherein displaying the preliminary information screen comprises enlarging the selected area to a predetermine size.

3. The method of claim 1, wherein the plurality of areas are arranged in a plurality of rows of the display.

4. The method of claim 3, wherein the displaying of the plurality of objects respectively in the plurality of areas that are arranged in the plurality of rows of the display comprises displaying the plurality of objects and a plurality of names of the respective objects in the plurality of areas.

5. The method of claim 1, wherein the preliminary information screen for the identified object includes information about a characteristic of the object.

6. The method of claim 5, wherein the information about the characteristic of the object is displayed using at least one of text and an image.

7. The method of claim 1, wherein displaying the execution screen of the identified object comprises converting the preliminary information screen to a full screen for executing the identified object.

8. The method of claim 1, wherein displaying the execution screen of the identified object comprises:
receiving a first input and a second input applied on the preliminary information screen;
maximizing the preliminary information screen to a full screen according to the second input; and
executing the identified object while maximizing the preliminary information screen to the full screen.

9. The method of claim 8, further comprising:
receiving a third input applied on the full screen when the execution screen of the identified object is maximized to the full screen and displayed; and
returning to a screen in which the plurality of objects are respectively displayed in the plurality of areas of the display of the electronic device, according to the third input,
wherein the third input includes at least one of a single touch input, a double touch input, a drag input having up/down/left/right directivity, and a tap input.

10. The method of claim 8, wherein each of the first input and the second input includes at least one of a single touch input, a double touch input, a drag input having up/down/left/right directivity, and a tap input.

11. The method of claim 1, further comprising:
receiving, if the identified object includes a plurality of execution steps, a first input applied on a screen in which two or more execution steps have already progressed; and
returning to an initial execution step of the object according to the first input.

12. An electronic device comprising:
a display configured to display a plurality of objects respectively in a plurality of areas; and
a controller configured to receive a selection of one of the plurality of areas, to identify an object corresponding to the selected area, to display a preliminary information screen for the identified object with at least one unselected object on the display, and to display an execution screen of the identified object on the display, if a selection of the preliminary information screen is received.

13. The electronic device of claim 12, wherein the preliminary information screen for the identified object is displayed by enlarging the selected area to a predetermine size.

14. The electronic device of claim 12, wherein the plurality of areas are arranged in a plurality of rows or in a plurality of columns.

15. The electronic device of claim 12, wherein the preliminary information screen for the identified object displays information about a characteristic of the object.

16. The electronic device of claim 15, wherein the information about the characteristic of the object is displayed using at least one of text and an image.

17. The electronic device of claim 12, wherein the controller converts the execution screen of the identified object to a full screen.

18. The electronic device of claim 12, wherein, if a first input and a second input applied on the preliminary information screen are received, the controller maximizes the preliminary information screen to a full screen according to the second input, and simultaneously executes the identified object.

19. The electronic device of claim 18, wherein if a third input applied on the full screen is received when the execution screen of the identified object is maximized to the full screen and displayed, the controller returns to a screen in which the plurality of objects are respectively displayed in the plurality of areas of the display of the electronic device, according to the third input, and
wherein the third input includes at least one of a single touch input, a double touch input, a drag input having up/down/left/right directivity, and a tap input.

20. The electronic device of claim 18, wherein each of the first input and the second input includes at least one of a single touch input, a double touch input, a drag input having up/down/left/right directivity, and a tap input.

21. The electronic device of claim 12, wherein if the identified object includes a plurality of execution steps, and a first input applied on a screen in which two or more execution steps have already progressed is received, the controller returns to an initial execution step of the object according to the first input.
